(19) United States
(12) Patent Application Publication
(10) Pub. No.: US 2025/0249605 A1
(43) Pub. Date: Aug. 7, 2025

(54) THIN PLATE CONVEYANCE APPARATUS

(71) Applicant: Honda Motor Co., Ltd., Tokyo (JP)

(72) Inventors: Satoru Uchiumi, Tokyo (JP); Toru Ikeda, Tokyo (JP); Yoshinori Tokunaga, Tokyo (JP)

(21) Appl. No.: 19/042,689

(22) Filed: Jan. 31, 2025

(30) Foreign Application Priority Data
Feb. 6, 2024 (JP) 2024-016164

(51) Int. Cl. B25J 15/06; H01M 8/026

(52) U.S. Cl. CPC B25J 15/0616; H01M 8/026

(57) ABSTRACT

A thin plate conveyance apparatus including a suction pad having a contact portion with a rectangular frame shape to come into contact with a thin plate with protrusions and recess arranged in a horizontal direction and generating a suction force by a negative pressure inside the contact portion, and a support part movably supporting the suction pad between a first position where the thin plate is suctioned and a second position where a suction to the thin plate is released. The contact portion includes a pair of first frame portions extending in the first direction and a pair of second frame portions extending in the second direction, and a width of the pair of first frame portions in the second direction is larger than a width of the recesses in the second direction or a width of the protrusions in the second direction.

### CROSS-REFERENCE TO RELATED APPLICATION

This application is based upon and claims the benefit of priority from Japanese Patent Application No. 2024-016164 filed on Feb. 6, 2024, the content of which is incorporated herein by reference.

### BACKGROUND OF THE INVENTION

### Field of the Invention

This invention relates to a thin plate conveyance apparatus configured to convey a thin plate such as a fuel cell separator.

### Description of the Related Art

In recent years, technological developments have been made on a fuel cell that contribute to energy efficiency in order to ensure access to energy that is affordable, reliable, sustainable and advanced by more people. As a conventional technology for conveying a separator included in this type of fuel cell, an apparatus is known in which an elastic member at the lower end of a suction pad, which has a shape approximately identical to the outer peripheral shape of the separator, is adhered to the surface of the separator with a flow path groove to suction the separator. Such an apparatus is described, for example, in Japanese Unexamined Patent Publication No. 2006-173058 (JP 2006-173058 A). In the apparatus described in JP 2006-173058 A, the surface of the elastic member is formed in an uneven shape corresponding to the flow path groove of the separator.

However, in the device described in JP 2006-173058 A, it is necessary to form the surface of the elastic member in the uneven shape corresponding to the flow path groove of the separator, which increases the cost.

### SUMMARY OF THE INVENTION

An aspect of the present invention is a thin plate conveyance apparatus configured to convey a thin plate having a plurality of recesses and a plurality of protrusions on a surface of the thin plate, the plurality of recesses and the plurality of protrusions being extending in a first direction and alternately provided in a second direction perpendicular to the first direction. The thin plate conveyance apparatus includes: a suction pad including a contact portion with a substantially rectangular frame shape to come into contact with the surface of the thin plate arranged in a substantially horizontal direction, the suction pad being configured to generate a suction force by a negative pressure inside the contact portion; and s support part configured to movably support the suction pad between a first position where the thin plate is suctioned and a second position where a suction to the thin plate is released. The contact portion includes a pair of first frame portions extending in the first direction and a pair of second frame portions extending in the second direction, the pair of second frame portions are shorter than the pair of first frame portions, and a width of each of the pair of first frame portions in the second direction is larger than a width of each of the plurality of recesses in the second direction or a width of each of the plurality of protrusions in the second direction.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack having a separator to which a thin plate conveyance apparatus according to an embodiment of the present invention is applied;

FIG. 2 is a cross-sectional view taken along line II-II in FIG. 1;

FIG. 3 is a perspective view showing a schematic configuration of the unitized electrode assembly included in the fuel cell stack of FIG. 1;

FIG. 4 is a rear view of the separator in FIG. 1;

FIG. 5 is a diagram schematically illustrating an overall configuration of the thin plate conveyance apparatus according to the embodiment of the present invention;

FIG. 6A is a plan view sowing a configuration of a suction pad as a reference example;

FIG. 6B is a plan view sowing a configuration of a suction pad as another reference example;

FIG. 7 is a plan view illustrating a configuration of a contact portion of the suction pad in FIG. 5;

FIG. 8 is a view showing a reference example of FIG. 7;

FIG. 9 is a view showing a modification of FIG. 7;

FIG. 10A is a cross-sectional view showing a modification on the suction pad; and

FIG. 10B is a cross-sectional view showing another modification on the suction pad.

### DETAILED DESCRIPTION OF THE INVENTION

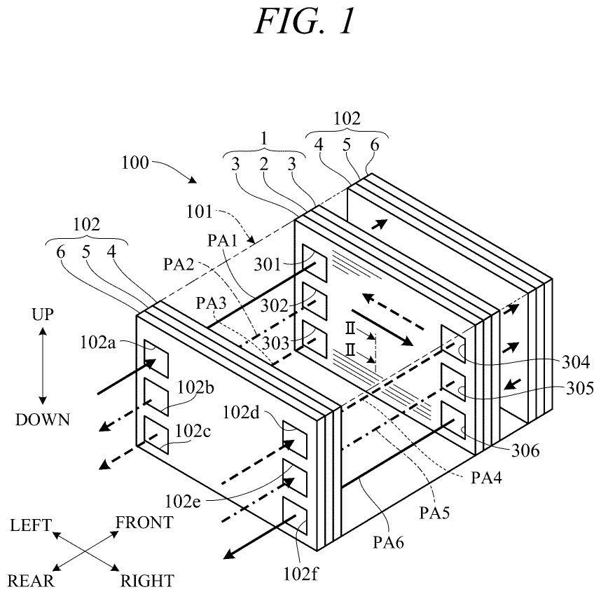

Hereinafter, an embodiment of the present invention will be described with reference to FIGS. 1 to 10B. A thin plate conveyance apparatus according to an embodiment of the present invention can be applied to various thin plates, each having recesses and protrusions alternately provided on their surfaces. Such a thin plate includes a separator for a fuel cell. The following describes an example in which the thin plate conveyance apparatus is applied to the fuel cell separator.

First, a configuration of a fuel cell stack which is a main configuration of the fuel cell will be described. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

FIG. 1 is a perspective view schematically showing an overall configuration of a fuel cell stack 100. Hereinafter, for the sake of convenience, three-axis directions orthogonal to each other as illustrated in the drawing are defined as a front-rear direction, a left-right direction, and an up-down direction, and a configuration of each part will be described according to such definitions. These directions may be different from a front-rear direction, a left-right direction, and an up-down direction of the vehicle. For example, the front-rear direction of FIG. 1 may be the front-rear direction, the left-right direction, or the up-down direction of the vehicle. The front-rear direction in FIG. 1 is a stacking direction of the fuel cell stack 100, and when assembling the fuel cell stack 100, the stacking direction is aligned with the direction of gravity.

As shown in FIG. 1, the fuel cell stack 100 has a cell stacked body 101 formed by stacking a plurality of power generation cells 1 in the front-rear direction, and end units 102 arranged at both front and rear ends of the cell stacked body 101, and the whole of the fuel cell stack 100 has a substantially rectangular parallelepiped shape. The length of the cell stacked body 101 in the left-right direction is longer than its length in the up-down direction. For convenience, a single power generation cell 1 is shown in FIG. 1.

The power generation cell 1 has a unitized electrode assembly (hereinafter, referred to as a “UEA”) 2 including a joint body (a membrane electrode assembly) that includes an electrolyte membrane and electrodes, and separators 3 and 3 arranged on both sides in the front-rear direction of the UEA 2. The UEA 2 can also be referred to as a membrane electrode structure. The UEA 2 and the separator 3 are alternately arranged in the front-rear direction. The separator 3 placed on the front side of the UEA 2 is called an anode separator, and the separator 3 placed on the rear side of the UEA 2 is called a cathode separator. Although not illustrated, the cell stacked body 101 is covered by a case with a substantially rectangular parallelepiped shape.

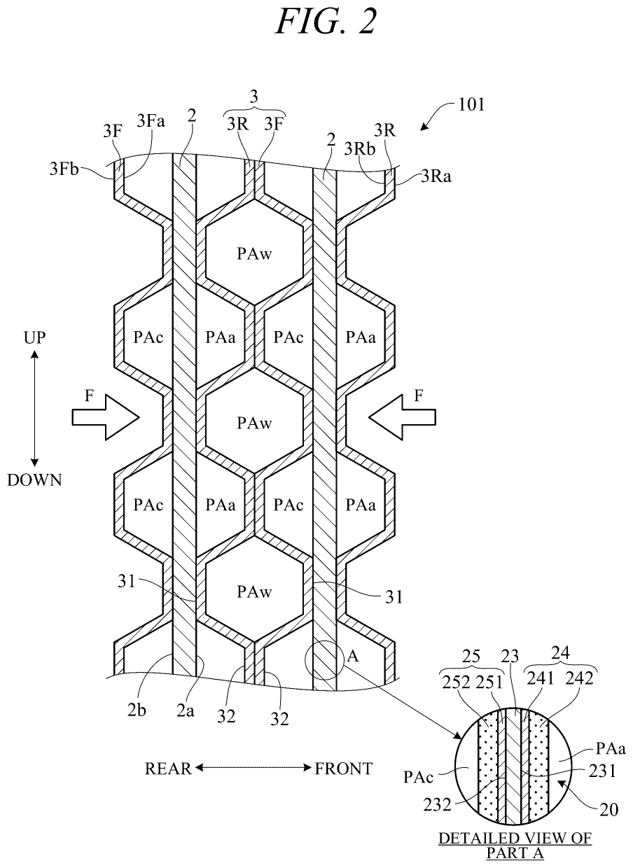

FIG. 2 is a cross-sectional view (along line II-II in FIG. 1) of the central part in the left-right direction of the cell stacked body 101. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The rear surface 3Fb of the front plate 3F and the front surface 3Ra of the rear plate 3R facing each other are joined together by welding or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling medium flows is formed. The generating surface of the power generation cell 1 is cooled by the flow of the cooling medium. Water, for example, can be used as the cooling medium. The surface (front surface 3Fa and rear surface 3Rb) of the separator facing the UEA 2 is configured with an uneven shape by press molding or the like to form a gas flow path between the surface of the separator 3 and the UEA 2. More specifically, a pair of front and rear separator 3 and 3 have a pair of front and rear protrusions 31 and 31 protruding towards the UEA 2, and a pair of front and rear recess portions 32 and 32, which are concavely formed in continuation to the pair of front and rear protrusions 31 and 31.

The pair of front and rear protrusions 31 and 31 come into contact with the front surface 2a and the rear surface 2b of the UEA 2. In the cell stacked body 101, a compressive load F is applied in the front-rear direction during the assembly of the fuel cell stack 100, and this compressive load F is maintained after the assembly of the fuel cell stack 100 is completed. Therefore, a predetermined surface pressure due to the compressive load F acts in the front-rear direction on the UEA 2 through the protrusions 31 and 31.

Between the front surface 2a of the UEA 2 and the rear plate 3R of the separator 3 facing this front surface 2a, an anode flow path PAa through which fuel gas flows is formed by the recess portion 32. Between the rear surface 2b of the UEA 2 and the front plate 3F of the separator 3 facing this rear surface 2b, a cathode flow path PAc through which oxidant gas flows is formed by the recess portion 32. For example, hydrogen gas can be used as the fuel gas, and air can be used as the oxidant gas. The fuel gas and the oxidant gas may be referred to as a reaction gas without being distinguished from each other.

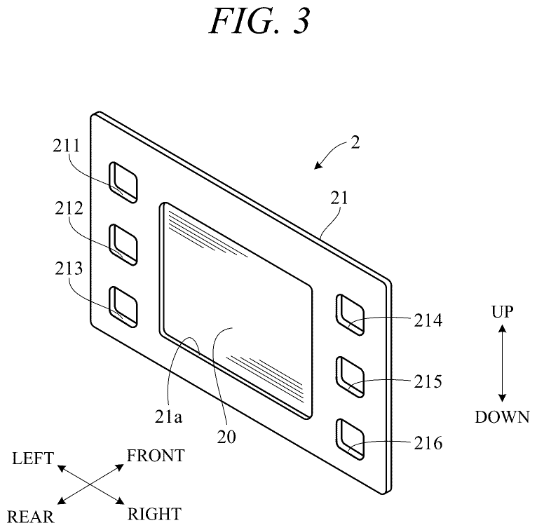

FIG. 3 is a perspective view showing a schematic configuration of the UEA 2. As shown in FIG. 3, the UEA 2 includes a substantially rectangular membrane electrode assembly (hereinafter, referred to as a “MEA”) 20 and a frame 21 that supports the MEA 20. As shown in the detailed view of part “A” in FIG. 1, the MEA 20 has an electrolyte membrane 23, an anode electrode 24 provided on a front surface 231 of the electrolyte membrane 23, and a cathode electrode 25 provided on a rear surface 232 of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 231 of the electrolyte membrane 23 and served as a reaction field for electrode reaction, and a gas diffusion layer 242 formed on the front surface of the electrode catalyst layer 241 to spread and supply the fuel gas. An intermediate layer (underlayer) can also be provided between the electrode catalyst layer 241 and the gas diffusion layer 242.

The cathode electrode 25 has an electrode catalyst layer 251 formed on the rear surface 232 of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 251 and the gas diffusion layer 252.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the UEA 2 along the gas flow.

As illustrated in FIG. 3, the frame 21 is a thin plate having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21.

Three through-holes 211 to 213 penetrating the frame 21 in the front-rear direction are opened side by side in the up-down direction on the left side of the opening 21a of the frame 21. Three through-holes 214 to 216 penetrating the frame 21 in the front-rear direction are opened side by side in the up-down direction on the right side of the opening 21a of the frame 21. The through-holes 211 to 216 are all shown as rectangular for convenience, but the shape of the through-holes 211 to 216 is not limited to this.

As shown in FIG. 1, in the separator 3 in front of and behind the UEA 2, through-holes 301 to 306 penetrating the separators 3 in the front-rear direction are opened at positions corresponding to the through-holes 211 to 216 of the frame 21. The through-holes 301 to 306 communicate with the through-holes 211 to 216 of the frame 21, respectively. The set of the through-holes 211 to 216 and 301 to 306 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

The front and rear end units 102 of the cell stacked body 101 have a plurality of plates 4 to 6 arranged to be stacked in the front-rear direction. More specifically, the end unit 102 includes a terminal plate 4 disposed on the inside in the front-rear direction, an insulating plate 5 disposed on the outside in the front-rear direction of the terminal plate 4, and an end plate 6 disposed on the outside in the front-rear direction of the insulating plate 5.

The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6. The end plate 6 is a plate-shaped member made of metal or resin having high strength.

In FIG. 1, for convenience, the end unit 102 and the cell stacked body 101 are shown as having the same size when viewed from the rear (the length in the up-down direction is the same and the length in the left-right direction is the same). However, in reality, the end unit 102 is larger than the cell stacked body 101, and the edge of the end unit 102 (for example, the end plate 6) protrude in the up-down and the left-right directions beyond the edge of the cell stacked body 101. The protruding portions of these end units 102 are fixed by bolts or the like to the front and rear ends of a case (not shown) provided around the cell stacked body 101.

The front end unit 102 is sometimes called a dry side end unit, and the rear end unit 102 is sometimes called a wet side end unit. In the wet side end unit 102, a plurality of through-holes 102a to 102f penetrating the end unit 102 in the front-rear direction are opened at positions corresponding to the through-holes 211 to 216 and 301 to 306. In the dry side end unit 102, such through holes 102a to 102f are not provided. For convenience, the through-holes 102a to 102f are all shown as having a substantially rectangular shape, but the shape of the through-holes 102a to 102f is not limited to this.

A fuel gas tank storing high-pressure fuel gas is connected to the through-hole 102a via an ejector, an injector, etc., and the fuel gas (anode gas) is supplied to the fuel cell stack 100 through the through-hole 102a along the flow path PA1 indicated by a solid line. This fuel gas is guided to the anode flow path PAa between the UEA 2 and the rear plate 3R of the separator 3 through the through-holes 211 and 301. The fuel gas (fuel exhaust gas) after passing through the anode flow path PAa is discharged from the through-hole 102f along the flow path PA6 indicated by a solid line through the through-holes 216 and 306.

A compressor for supplying oxidant gas is connected to the through-hole 102d, and the oxidant gas (cathode gas) compressed by the compressor is supplied to the fuel cell stack 100 through the through-hole 102d along the flow path PA4 indicated by a dotted line. This oxidant gas is guided to the cathode flow path PAc between the UEA 2 and the front plate 3F of the separator 3 through the through-holes 214 and 304. The oxidant gas (oxidant exhaust gas) after passing through the cathode flow path PAc is discharged from the through-hole 102c along the flow path PA3 indicated by a dotted line through the through-holes 213 and 303.

A pump for supplying cooling medium is connected to the through-hole 102e, and the cooling medium is supplied to the fuel cell stack 100 through the through-hole 102e along the flow path PA5 indicated by a chain line. This cooling medium is guided to the cooling flow path PAw between the front plate 3F and the rear plate 3R of the separator 3 through the through-holes 215 and 305. The cooling medium after passing through the cooling flow path PAw is discharged from the through-hole 102b along the flow path PA2 indicated by a chain line through the through-holes 212 and 302. The discharged cooling medium is cooled by heat exchange in a radiator and is supplied again to the fuel cell stack 100 through the through-hole 102e.

A schematic configuration of the fuel cell stack 100 has been described above. Hereinafter, not only the front plate 3F and the rear plate 3R joined together, but also each of the front plate 3F and the rear plate 3R is also referred to as the separator 3. The thin plate conveyance apparatus according to the present embodiment is used in a manufacturing process of the fuel cell stack 100. Specifically, the thin plate conveyance apparatus takes out the separator 3 (for example, the front plate 3F and the rear plate 3R before being joined to each other) stacked on a tray from the tray, and conveys the separator 3 to a place where a predetermined manufacturing process is performed.

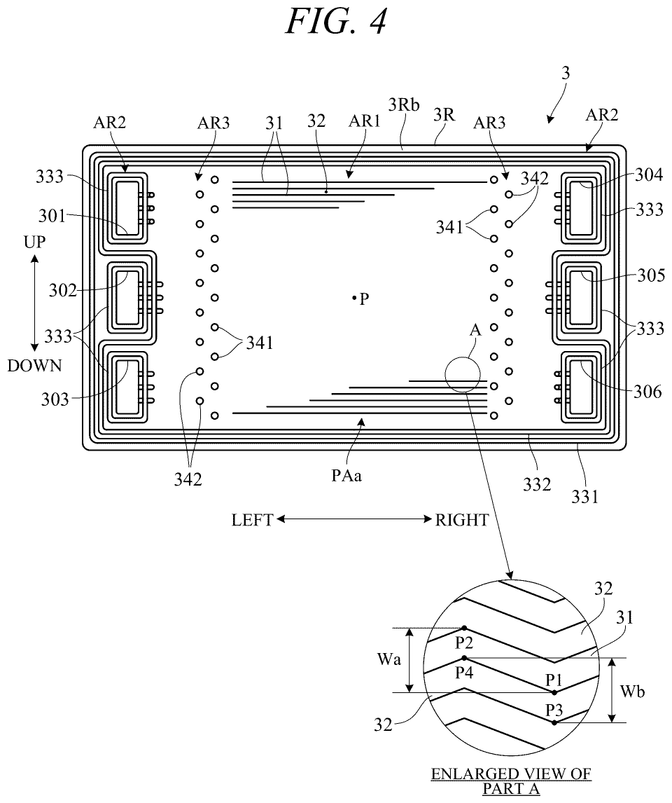

FIG. 4 is a rear view (a view viewed from the rear) of the separator 3. That is, FIG. 4 is a view illustrating the rear surface 3Rb of the rear plate 3R facing the anode electrode 24 on the front surface 2a of the UEA 2. A point P in the drawing is an intermediate point in the left-right direction and an intermediate point in the up-down direction of the separator 3, and is referred to as a center point. The left-right direction and the up-down direction in FIG. 4 correspond to a longitudinal direction and a transverse direction of the separator 3, respectively.

In FIG. 4, a region facing the MEA 20 of the UEA 2, that is, a region AR1 facing the power generation surface is referred to as an active region of the separator 3, and regions other than the active region are referred to as inactive regions. Since the active region AR1 is located at the central portion of the separator 3 in the left-right direction, the active region AR1 is sometimes referred to as a central region of the separator 3.

Of the inactive regions, a region at an end in the left-right direction where the through holes 301 to 306 are provided is referred to as an end region AR2 of the separator 3. Of the inactive regions, a region inside the end region AR2 in the left-right direction is referred to as a connection region AR3 of the separator 3. The connection regions AR3 are located between the active region AR1 and the left and right end regions AR2.

In the active region AR1 of the separator 3, the plurality of protrusions 31 are provided to protrude rearward at equal intervals in the up-down direction over substantially the entire region although a part thereof is not illustrated. Each of the plurality of protrusions 31 extends in the left-right direction, and the recess portion 32 is provided between the protrusions 31 and 31 adjacent in the up-down direction. The anode flow path PAa (FIG. 2) is formed between the plurality of recess portions 32 and the front surface 2a of the MEA 20.

More specifically, as illustrated in an enlarged view of a portion “A” in FIG. 4, the protrusion 31 and the recess portion 32 extend in the left-right direction while meandering in the up-down direction. Therefore, the length in the up-down direction of the protrusion 31, that is, a length (referred to as a protrusion meandering width) Wa from a lower end point P1 to an upper end point P2 of the protrusion 31 is longer than the length in the up-down direction (referred to as a protrusion width) of the protrusion 31 when the protrusion 31 does not meander. Additionally, the length in the up-down direction of the recess portion 32, that is, a length (referred to as a flow path meandering width) Wb from a lower end point P3 to an upper end point P4 of the recess portion 32 is longer than the length in the up-down direction (referred to as a flow path width) of the recess portion 32 when the recess portion 32 does not meander.

The protrusion meandering width Wa and flow path meandering width Wb are equal to each other (Wa=Wb). The protrusion meandering width Wa may be longer than the flow path meandering width Wb (Wa>Wb), and the flow path meandering width Wb may be longer than the protrusion meandering width Wa (Wb>Wa). As the recess portion 32 meanders in the up-down direction, the area of the anode flow path PAa increases, and the flow velocity of fuel gas flowing through the anode flow path PAa decreases. As a result, the reaction by the flow of the fuel gas is promoted.

The rear surface 3Rb of the separator 3 (rear plate 3R) is provided with a plurality of sealing bead portions, that is, metal bead seals protruding rearward toward the frame 21. The plurality of bead portions include an outer bead portion 331, an inner bead portion 332, and an end bead portion 333. In the connection region AR3 of the separator 3, a plurality of substantially columnar embossed portions 341, 342 protruding in the front-rear direction are provided.

The protrusion 31, the recess portion 32, the metal bead seal, and the like are formed by pressing the rear plate 3R. Although not illustrated, the protrusion 31, the recess portion 32, the metal bead seal, and the like are similarly formed on the front plate 3F by pressing the front plate 3F.

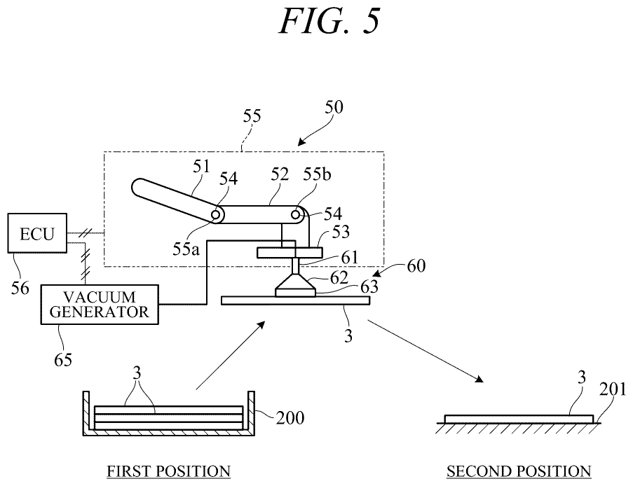

FIG. 5 is a diagram schematically illustrating an overall configuration of a thin plate conveyance apparatus 50 according to this embodiment. As illustrated in FIG. 5, the thin plate conveyance apparatus 50 includes an industrial robot 55 having articulated arms 51 and 52 and a hand 53 provided at the end of the arm 52, and a suction pad 60 supported by the hand 53.

The arm 51 and the arm 52 are pivotally coupled with each other through a pivot shaft 55a, and the arm 52 and the hand 53 are pivotally coupled with each other through a pivot shaft 55b. The configuration of the robot 55 (the number of arms and the like) is not limited to the illustrated one. The arms 51 and 52 and the hand 53 are rotated by the drive of an actuator 54 such as a servo motor provided on the pivot shafts 55a and 55b, for example, which changes the position and posture of the hand 53. The actuator 54 is controlled by an ECU 56. The ECU 56 is an electronic control unit including a computer having a CPU, a ROM, a RAM, and other peripheral circuits.

The suction pad 60 includes a rod portion 61 extending in the up-down direction below the hand 53 and a pad portion 62 provided at the lower end of the rod portion 61. The upper end of the rod portion 61 is supported by the hand 53. A support member may be interposed between the hand 53 and the rod portion 61, and the rod portion 61 may be supported by the hand 53 via the support member. A support member may be provided so that the suction pad 60 can move up and down with respect to the hand 53 via a spring.

A lower end surface of the pad portion 62 is open. The pad portion 62 has a cavity therein, and a side surface of the pad portion 62 is formed in a tapered shape so that the area of the cavity in the horizontal plane gradually increases from the upper side to the lower side. A contact portion 63 having a substantially rectangular frame shape is provided at the lower end of the pad portion 62. The contact portion 63 is formed of an elastic body such as a rubber material. A lower end surface of the contact portion 63 is formed as a flat surface, and the lower end surface abuts on an upper surface of the separator 3.

The rod portion 61 of the suction pad 60 is formed in a cylindrical shape, and an internal passage is connected to a vacuum generator 65. By generating negative pressure (vacuum pressure) inside the pad portion 62 via the rod portion 61 by the vacuum generator 65, the separator 3 can be suctioned onto the suction pad 60. The operation of the vacuum generator 65 is controlled by the ECU 56.

The hand 53 is raised and lowered above a tray 200 whose upper surface is open. The separators 3 (front plate 3F, rear plate 3R) are stored in the tray 200 in a stacked state. The tray 200 is installed at a first position. The hand 53 moves from the first position to a second position in a state where the separator 3 is suctioned by the suction pad 60 according to a command from the ECU 56. As a result, the separator 3 is conveyed from the first position to the second position.

A placing table 201 for performing predetermined processing on the separator 3 is provided at the second position. When the separator 3 moves to a predetermined position above the placing table 201 (when the movement to the predetermined position is detected by a sensor), the operation of the vacuum generator 65 is released by a command from the ECU 56, whereby the separator 3 is placed on the placing table 201. Thereafter, the hand 53 returns to the first position by a command from the ECU 56, and repeats the conveyance of the separator 3 from the first position to the second position.

When the separator 3 is suctioned by the suction pad 60, if the contact portion 63 comes into contact with a flat surface of the separator 3 having no unevenness, the suction force of the suction pad 60 due to the negative pressure can be increased, and the suction of the separator 3 is facilitated. However, as illustrated in FIG. 4, the surface of the separator 3 is formed in an uneven shape in all of the active region AR1, the end region AR2, and the connection region AR3, and there is no flat surface with which the suction pad 60 can abut.

If the separator 3 is provided with a flat surface with which the suction pad 60 can abut, the size of the separator 3 increases, leading to an increase in cost. In addition, if the active region AR1 is narrowed to provide a flat surface with which the suction pad 60 can abut, the performance of the fuel cell is deteriorated. Therefore, in the present embodiment, the contact portion 63 of the suction pad 60 is brought into contact with the active region AR1 of the separator 3 in which the protrusion 31 and the recess portion 32 are regularly arranged to suction the separator 3.

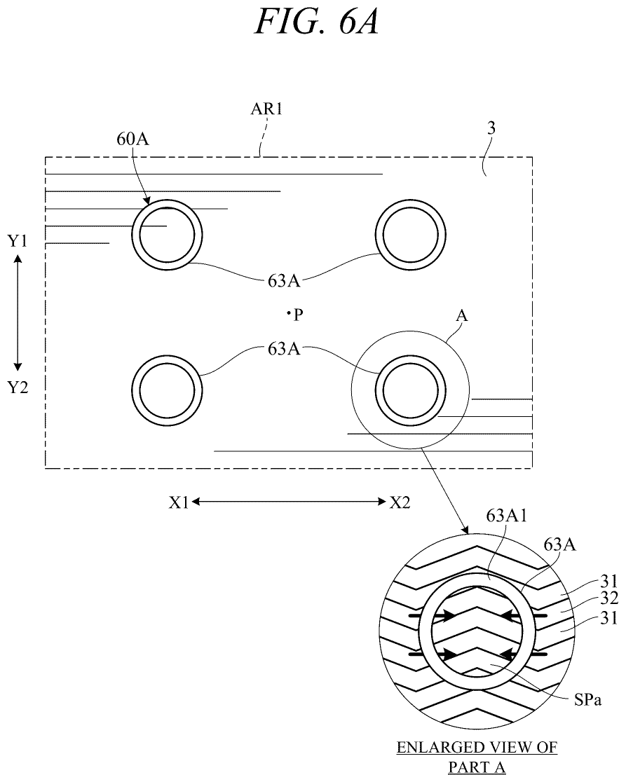

A configuration of the suction pad 60 (particularly, the contact portion 63) will be described. FIGS. 6A and 6B are plan views illustrating configurations of contact portions 63A and 63B included in a thin plate conveyance apparatus as a reference example, respectively. FIGS. 6A and 6B illustrate a state in which the contact portion 63A is in contact with the active region AR1 on the surface of the separator 3 (for example, the rear surface 3Rb of the rear plate 3R). At this time, the surface of the separator 3 faces upward, and the longitudinal direction (the left-right direction in FIG. 4) of the separator 3 is indicated as an X1-X2 direction, and the transverse direction is indicated as a Y1-Y2 direction. FIGS. 6A and 6B illustrate the entire active region AR1 of the separator 3, and illustration of regions other than the active region AR1 is omitted.

In the example of FIG. 6A, the thin plate conveyance apparatus includes four suction pads 60A. The suction pad 60A has a substantially ring shape in plan view. The contact portions 63A of the four suction pads 60A are disposed at four positions around the center point P in the active region AR1 of the separator 3, and a lower end surface 63A1 thereof is brought into contact with the surface of the separator 3. As illustrated in the enlarged view of a portion “A” in FIG. 6A, the lower end surface 63A1 of the contact portion 63A faces the protrusion 31 and the recess portion 32 on the surface of the separator 3.

When the vacuum generator 65 is operated in this state, air flows into an inner space SPa of the contact portion 63A via gaps between the lower end surface 63A1 of the suction pad 60A and the recess portion 32 as indicated by arrows. In FIG. 6A, since the contact portion 63A has a substantially ring shape, the area of the lower end surface 63A1 facing the protrusion 31 is substantially equal to the area of the lower end surface 63A1 facing the recess portion 32. For this reason, the amount of air flowing into the inner space SPa of the contact portion 63A via the recess portion 32 increases, and it is difficult to generate a sufficient negative pressure in the inner space SPa of the contact portion 63A. As a result, it is necessary to increase the capacity of the vacuum generator 65 in order to obtain a sufficient suction force for the separator 3, which leads to an increase in cost.

Also in the example of FIG. 6B, similarly to FIG. 6A, the thin plate conveyance apparatus has four suction pads 60B. The suction pad 60B has a substantially square frame shape in plan view. The contact portions 63B of the four suction pads 60B are disposed at four positions around the center point P in the active region AR1 of the separator 3, and a lower end surface 63B1 thereof is brought into contact with the surface of the separator 3. As illustrated in the enlarged view of a portion B in FIG. 6B, the lower end surface 63B1 of the contact portion 63B faces the protrusion 31 and the recess portion 32 on the surface of the separator 3.

In FIG. 6B, among four side walls 63B11,63B12,63B13, and 63B14 of the contact portion 63B, the lower end surface 63B1 of one side wall 63B11 extending in the X1-X2 direction abuts on the protrusion 31 of the separator 3, and the lower end surface 63B1 of the other side wall 63B13 faces the recess portion 32. Additionally, the lower end surfaces 63B1 of the pair of side walls 63B12 and 63B14 extending in the Y1-Y2 direction alternately face the protrusion 31 and the recess portion 32. Therefore, more than half of the area of the lower end surface 63B1 of the suction pad 60B faces the recess portion 32. Therefore, when the vacuum generator 65 is operated, a large amount of air flows into an inner space SPb of the contact portion 63B via gaps between the lower end surface 63B1 and the recess portion 32 as indicated by arrows, and it is difficult to generate a sufficient negative pressure in the inner space SPb of the contact portion 63B. As a result, it is necessary to increase the capacity of the vacuum generator 65 in order to obtain a sufficient suction force for the separator 3, which leads to an increase in cost.

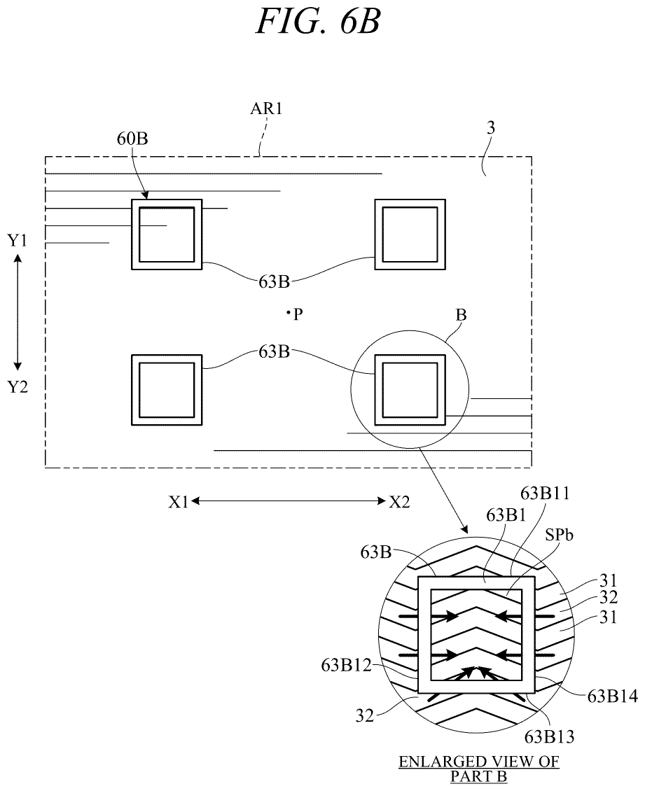

FIG. 7 is a plan view illustrating a configuration of the contact portion 63 of the suction pad 60 included in the thin plate conveyance apparatus 50 according to the present embodiment. As illustrated in FIG. 7, the thin plate conveyance apparatus 50 includes a single suction pad 60. The contact portion 63 of the suction pad 60 has a substantially rectangular frame shape in plan view. The suction pad 60 is disposed such that the center of the contact portion 63 is located at the center point P of the separator 3.

The contact portion 63 has a pair of side walls 631 and 633 extending in the X1-X2 direction and a pair of side walls 632 and 634 extending in the Y1-Y2 direction. The side walls 631 and 633 are longer than the side walls 632 and 634. For example, the length of the side walls 631 and 633 are twice or more the length of the side walls 632 and 634. A width W of the contact portion 63 is constant over the entire circumference. That is, the length (width W) of the side walls 631 and 633 in the Y1-Y2 direction and the length (width W) of the side walls 632 and 634 in the X1-X2 direction are equal to each other. As illustrated in an enlarged view of a portion “A” in FIG. 7, the width W of the contact portion 63 is set to be wider than the flow path meandering width Wb.

When the separator 3 is conveyed from the first position to the second position by the robot 55, the ECU 56 first outputs a control signal to the actuator 54 so that the center of the suction pad 60 coincides with the center point P of the separator 3 at the first position, and drives the robot 55. When the suction pad 60 moves to the first position, the lower end surface 630 of each of the side walls 631 and 633 abuts on the upper surface of the protrusion 31 of the separator 3 over the entire length in the X1-X2 direction. More specifically, as illustrated in an enlarged view of a portion “A” in FIG. 7, the lower end surface 630 of each of the side walls 631 and 633 abuts on the upper surfaces of the pair of protrusions 31 provided on both sides of the recess portion 32.

As a result, the lower end surface 630 of each of the side walls 631 and 633 is sealed. Therefore, when the vacuum generator 65 is operated to start suction of the separator 3 by the suction pad 60, it is possible to prevent air from flowing into an inner space SP1 from an outer space SP2 of the contact portion 63 via the gap between the lower end surface 630 and the recess portion 32. As a result, the separator 3 can be conveyed from the first position to the second position by the robot 55 while a high suction force by the suction pad 60 is maintained. When the separator 3 is conveyed to the second position, the operation of the vacuum generator 65 is released by a command from the ECU 56. As a result, the separator 3 is placed on the placing table 201 as illustrated in FIG. 5.

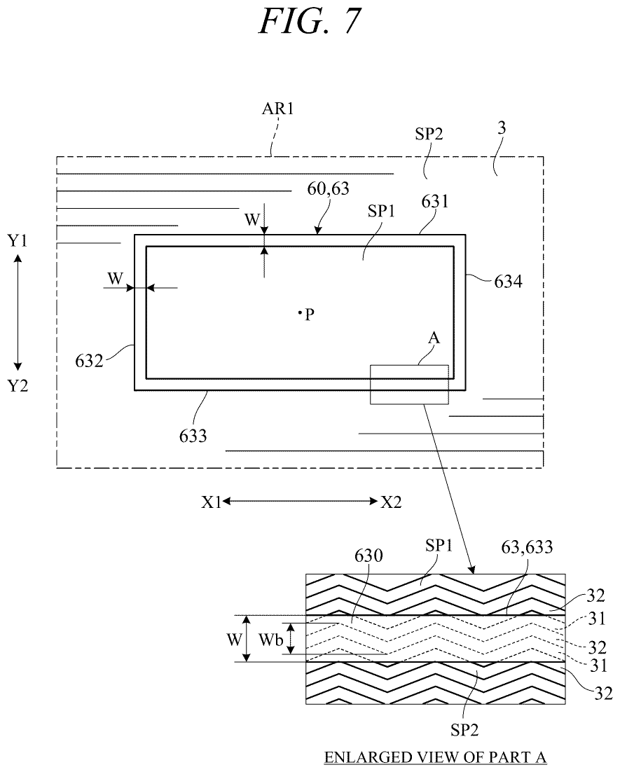

FIG. 8 is a reference example of FIG. 7, and is an example in a case where the width W of the contact portion 63 is made narrower than the flow path meandering width Wb. In the example illustrated in FIG. 8, a part of the recess portion 32 is exposed without being covered by the lower end surface 630 of the contact portion 63 in plan view. Therefore, the inner space SP1 and the outer space SP2 of the contact portion 63 communicate with each other via the recess portion 32. As a result, as indicated by arrows in FIG. 8, air flows into an inner space SP0 of the contact portion 63 beyond the side wall 633.

On the other hand, in the present embodiment, the width W of each of the side walls 631 and 633 is set to be wider than the flow path meandering width Wb. Therefore, the lower end surface 630 of each of the side walls 631 and 633 functions as a seal portion. There is a gap between the lower end surface 630 of each of the side walls 632 and 634 and the recess portion 32, but the side walls 631 and 633 are longer than the side walls 632 and 634. Therefore, the amount of air flowing into the inner space SP1 from the outer space SP2 of the contact portion 63 beyond each of the side wall 632 and 634 is small, and a sufficient negative pressure can be generated in the inner space SP1 of the contact portion 63. As a result, the suction force of the suction pad 60 due to the negative pressure increases, and the separator 3 can be easily suctioned.

The pad portion 62 of the suction pad 60 is made of a resin or a rubber material. Accordingly, as the number of times of use of the thin plate conveyance apparatus 50 increases, the pad portion 62 (the contact portion 63) which is brought into contact with the separator 3 wears, and the pad portion 62 needs to be replaced. In this case, as in the examples illustrated in FIGS. 6A and 6B, when the number of the suction pads 60A and 60B is four, a large amount of time is required for the replacement work of the pad portion. In this regard, in the present embodiment, since the single suction pad 60 is used, the time required for the replacement operation can be shortened.

According to the present embodiment, the following operations and effects are achievable.

(1) The thin plate conveyance apparatus 50 is configured to convey the separator 3 having the plurality of recess portions 32 and the plurality of protrusions 31 on the surface, the recesses portions 32 and the protrusions 31 extending in the X1-X2 direction and alternately provided in the Y1-Y2 direction (FIGS. 4 and 5). The thin plate conveyance apparatus 50 includes: the suction pad 60 that has the contact portion 63 having a substantially rectangular frame shape in plan view and coming into contact with a surface of the separator 3 arranged in a substantially horizontal direction, and that generates a suction force due to a negative pressure in the inner space SP1 of the contact portion 63; and the robot 55 that movably supports the suction pad 60 between a first position where the separator 3 is suctioned and a second position where the suction is released (FIGS. 5 and 7). The contact portion 63 includes the pair of side walls 631 and 633 extending in the X1-X2 direction and the pair of side walls 632 and 634 shorter than the side walls 631 and 633 extending in the Y1-Y2 direction (FIG. 7). The width W of each of the side walls 631 and 633 in the Y1-Y2 direction is larger than the width (flow path meandering width) Wb of the recess portion 32 in the Y1-Y2 direction (FIG. 7).

According to this configuration, the gap between the recess portion 32 of the separator 3 and each of the side walls 631 and 633 of the suction pad 60 is closed over the entire length of each of the side walls 631 and 633, and the lower end of each of the side walls 631 and 633 functions as a seal portion. In this case, since the side walls 631 and 633 extending in the X1-X2 direction are longer than the side walls 632 and 634 extending in the Y1-Y2 direction, more than half of the area of the lower end surface 630 of the contact portion 63 functions as a seal portion. Accordingly, the inner space SP0 of the suction pad 60 can be brought into a negative pressure state, and a high suction force of the suction pad 60 for the separator 3 can be generated. As a result, it is not necessary to form the lower end surface 630 of the contact portion 63 in an uneven shape, and the separator 3 can be satisfactorily suctioned using the inexpensive suction pad 60. Furthermore, it is not necessary to use a large-capacity vacuum generator 65, and it is possible to suppress an increase in cost of the thin plate conveyance apparatus 50. In order to close the gap between the suction pad 60 and the recess portion 32, it is conceivable to form the contact portion 63 of the suction pad 60 with a material having flexibility. However, with this configuration, when the separator 3 has undulation or warpage, it is difficult to accurately position the separator 3. In this regard, in the present embodiment, even when the separator 3 has undulation or warpage, the separator 3 can be accurately positioned.

(2) The robot 55 supports the suction pad 60 such that the lower end surfaces 630 of the side walls 631 and 633 abut on the pair of protrusions 31 and 31 provided on both sides of the recess portion 32 at the first position (FIG. 7). As a result, since the upper sides of the recess portions 32 extending in the X1-X2 direction are covered by the lower end surfaces 630 of the side walls 631 and 633, the flow of air to the inner space SP1 via the recess portion 32 can be reliably blocked.

(3) The plurality of recess portions 32 extend in the X1-X2 direction while meandering in the Y1-Y2 direction (FIG. 7). When the recess portion 32 meanders, the width Wb of the flow path increases, but in the present embodiment, the suction pad 60 is formed such that the width W of each of the side walls 631 and 633 of the contact portion 63 is wider than the flow path meandering width Wb (FIG. 7). As a result, it is possible to reliably seal between the lower end surface 630 of each of the side walls 631 and 633 and the separator 3.

(4) The thin plate conveyance apparatus 50 is applied to conveyance of the separator 3 for the fuel cell. In the separator 3, a flow path groove (anode flow path PAa, cathode flow path PAc) in which a reaction gas flows is formed by the plurality of recess portions 32 (FIG. 4). In such a separator 3, since the recess portion 32 and the protrusion 31 are regularly arranged in the central active region AR1, the separator 3 is suitable as an application target of the thin plate conveyance apparatus 50.

(5) The thin plate conveyance apparatus 50 includes a single suction pad 60 disposed at the center of the separator 3 (FIG. 7). As a result, since it is only necessary to replace the single pad portion 62 when replacing the pad portion 62, the replacement work can be performed in a short time.

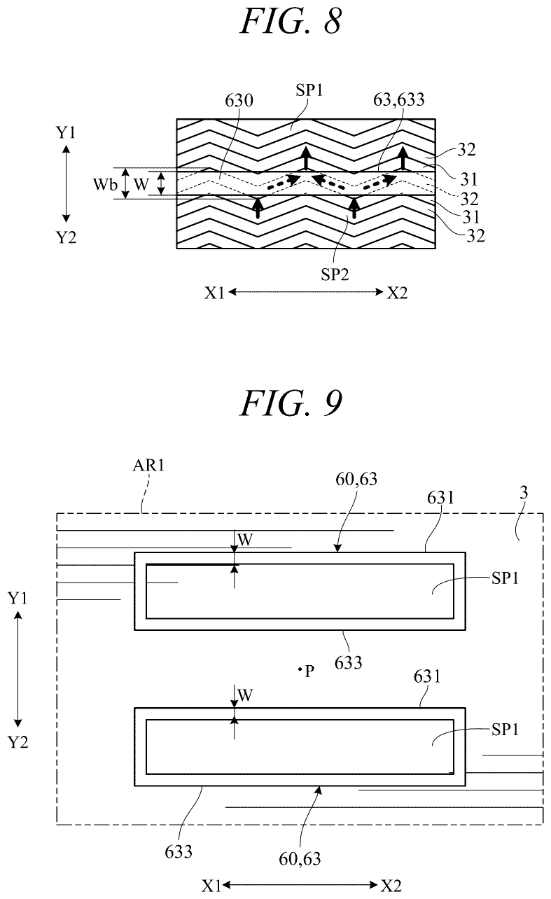

The above embodiments can be modified into various forms. Hereinafter, some modifications will be described. In the above embodiment, the thin plate conveyance apparatus 50 includes the single suction pad 60, but it may include a plurality of suction pads 60. FIG. 9 is a diagram illustrating an example of the configuration. In FIG. 9, the thin plate conveyance apparatus includes a pair of suction pads 60 having the same shape. The pair of suction pads 60 are disposed symmetrically in the Y1-Y2 direction with respect to a center point P. A width W and a length in the X1-X2 direction of a contact portion 63 in FIG. 9 are the same as the width W and the length in the X1-X2 direction of the contact portion 63 in FIG. 7. On the other hand, a length in the Y1-Y2 direction of the single contact portion 63 in FIG. 9 is half the length in the Y1-Y2 direction of the contact portion 63 in FIG. 7.

According to the configuration of FIG. 9, too, the gap between the recess portion 32 of the separator 3 and each of the side walls 631 and 633 of the suction pad 60 is closed over the entire length of each of the side walls 631 and 633, and the lower end of each of the side walls 631 and 633 functions as a seal portion. As a result, a sufficient negative pressure can be generated in the inner space SP1 of the contact portion 63 of the recess portion 32, and the separator 3 can be easily suctioned by the pair of suction pads 60. In addition, since the end in the Y1 direction and the end in the Y2 direction of the suction pads 60 are disposed farther away from the center point P in the Y1-Y2 direction than those in FIG. 7, the separator 3 can be stably supported over a wide range.

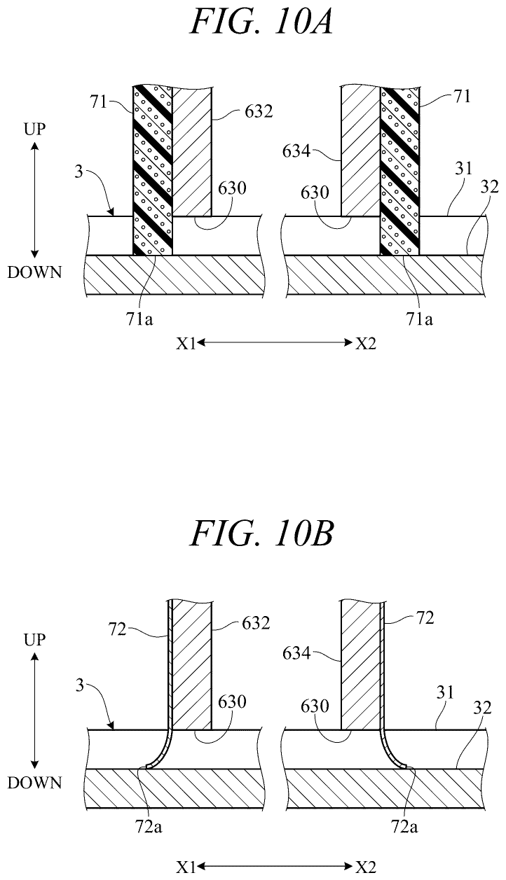

In order to prevent the flow of air to the inner space SP1 via the gap between each of the side walls 632 and 634 of the suction pad 60 and the recess portion 32, a seal portion (seal member) may be provided on each of the side walls 632 and 634. FIGS. 10A and 10B are cross-sectional views of main parts of a suction pad 60 in the vertical direction, each illustrating an example. In FIG. 10A, a foaming member 71 such as urethane foam having shrinkability is attached to an outer side surface of each of the side walls 632 and 634 in the X1-X2 direction. A lower end surface 71a of the foaming member 71 protrudes downward from a lower end surface 630 of each of the side walls 632 and 634. As a result, a part of the foaming member 71 is pushed into the recess portion 32, and a gap between the lower end surface 630 of each of the side walls 632 and 634 and the recess portion 32 can be closed.

In FIG. 10B, a flexible resin film member 72 is attached to an outer side surface of each of the side walls 632 and 634 in the X1-X2 direction. A lower end surface 72a of the film member 72 protrudes downward from a lower end surface 630 of each of the side walls 632 and 634. In the lower end of the film member 72 (a portion protruding downward from the lower end surface 630 of the side wall 632, 634), cuts are provided at equal intervals in the Y1-Y2 direction in the up-down direction, and the film member 72 is formed in a pleated shape. As a result, a part of the film member 72 is pushed into the recess portion 32, and a gap between the lower end surface 630 of each of the side walls 632 and 634 and the recess portion 32 can be closed.

In the above embodiment, the width W of each of the side walls 631 and 633 of the suction pad 60 is set to be wider than the width (flow path meandering width) Wb of the recess portion 32, but it may be set to be wider than the width (protrusion meandering width) Wa of the protrusion 31. Accordingly, when the suction pad 60 is moved to the first position, the lower end surface 630 of each of the side walls 631 and 633 can be brought into contact with the upper surface of the protrusion 31 of the separator 3 located at the first position over the entire X1-X2 direction of the side wall 631, 633. As a result, it is possible to prevent air from flowing into the inner space SP1 of the suction pad 60 via the gap between each of the side walls 631 and 633 and the recess portion 32.

The flow path meandering width Wb may be wider than the protrusion meandering width Wa. In this case, the width W of each of the side walls 631 and 633 may be set wider than the meandering width Wa of the protrusion, and the width W of each of the side walls 631 and 633 may be set narrower than the flow path meandering width Wb, thereby minimizing the width W of each of the side walls 631 and 633. The protrusion meandering width Wa may be wider than the flow path meandering width Wb. In this case, the width W of each of the side walls 631 and 633 may be set wider than the flow path meandering width Wb, and the width W of each of the side walls 631 and 633 may be set narrower than the protrusion meandering width Wa, thereby minimizing the width W of each of the side walls 631 and 633.

In the above embodiment, the separator 3 of the fuel cell stack 100, which has multiple recess portions 32 and protrusions 31 alternately arranged in the Y1-Y2 direction (a second direction) while extending in the X1-X2 direction (a first direction), is applied to the thin plate conveyance apparatus 50. However, a thin plate conveyance apparatus of the present invention can also be similarly applied to other thin plates having such recess portions and protrusions. In the above embodiment, the multiple recess portions 32 on the surface of the separator 3 are arranged to extend in the X1-X2 direction while meandering in the Y1-Y2 direction, but the recess portions do not necessarily have to meander.

In the above embodiment, the robot 55 with a multi-joint arm is configured to support the suction pad 60 so that the suction pad can move from the first position to the second position, but the configuration of a support part is not limited to the one described above. In the above embodiment, the separator 3 is stored in the tray 200 at the first position and placed on the placing table 201 at the second position, but the first and second positions may be other positions. In the above embodiment, regarding the width W of the side walls 631 to 634 of the contact portion 63, the width W of the pair of side walls 631 and 633 (a pair of first frame portions) extending in the first direction and the width W of the pair of side walls 632 and 634 (a pair of second frame portions) extending in the second direction are set to the same value, but the width of the pair of first frame portions and the width of the pair of second frame portions may be set to different values.

The above embodiment can be combined as desired with one or more of the above modifications. The modifications can also be combined with one another.

According to the present invention, it is possible to satisfactorily suction a separator with an uneven surface using a low-cost suction pad.

Above, while the present invention has been described with reference to the preferred embodiments thereof, it will be understood, by those skilled in the art, that various changes and modifications may be made thereto without departing from the scope of the appended claims.

What is claimed is:

1. A thin plate conveyance apparatus configured to convey a thin plate having a plurality of recesses and a plurality of protrusions on a surface of the thin plate, the plurality of recesses and the plurality of protrusions being extending in a first direction and alternately provided in a second direction perpendicular to the first direction, the thin plate conveyance apparatus comprising:
a suction pad including a contact portion with a substantially rectangular frame shape to come into contact with the surface of the thin plate arranged in a substantially horizontal direction, the suction pad being configured to generate a suction force by a negative pressure inside the contact portion; and
a support part configured to movably support the suction pad between a first position where the thin plate is suctioned and a second position where a suction to the thin plate is released, wherein
the contact portion includes a pair of first frame portions extending in the first direction and a pair of second frame portions extending in the second direction,
the pair of second frame portions are shorter than the pair of first frame portions, and
a width of each of the pair of first frame portions in the second direction is larger than a width of each of the plurality of recesses in the second direction or a width of each of the plurality of protrusions in the second direction.

2. The thin plate conveyance apparatus according to claim 1, wherein
the width of the each of the pair of first frame portions in the second direction is larger than the width of the each of the plurality of recesses in the second direction,
the plurality of protrusions include a pair of protrusions provided on both sides of the each of the plurality of recesses in the second direction, and
the support part is configured to support the suction pad so that the each of the pair of first frame portions comes into contact with the pair of protrusions in the first position.

3. The thin plate conveyance apparatus according to claim 1, wherein
the width of the each of the pair of first frame portions in the second direction is larger than the width of the each of the plurality of protrusions in the second direction,
the plurality of recesses include a pair of recesses provided on both sides of the each of the plurality of protrusions in the second direction, and
the support part is configured to support the suction pad so that the each of the pair of first frame portions is disposed over the pair of recesses in the first position.

4. The thin plate conveyance apparatus according to claim 1, wherein
the plurality of recesses extend in the first direction in a meandering manner, and
the width of the each of the plurality of recesses in the second direction corresponds to a length between an edge on a first side and an edge on a second side opposite to the first side, in the second direction of the each of the plurality of recesses.

5. The thin plate conveyance apparatus according to claim 1, wherein
the thin plate is a fuel cell separator in which flow path grooves for a reaction gas are formed by the plurality of recesses.

6. The thin plate conveyance apparatus according to claim 5, wherein
the suction pad is a single suction pad disposed at a center portion of the fuel cell separator.

7. The thin plate conveyance apparatus according to claim 5, wherein
the suction pad is a pair of suction pads disposed on both sides in the second direction of a center portion of the fuel cell separator.

8. The thin plate conveyance apparatus according to claim 1, further comprising
a pair of seal members having a shrinkability or a flexibility and attached to outer side surfaces of the pair of second frame portions in the first direction, wherein
each of the pair of seal members includes an end portion coming into contact with the surface of the thin plate,
the contact portion includes an end portion coming into contact with the surface of the thin plate, and
a protrusion amount of the end portion of the each of the pair of seal members to the surface of the thin plate is larger than a protrusion amount of the end portion of the contact portion to the surface of the thin plate.
